(19) United States
(12) Patent Application Publication
(10) Pub. No.: US 2023/0288699 A1
(43) Pub. Date: Sep. 14, 2023

(54) INTERLAYERS HAVING ENHANCED OPTICAL PERFORMANCE

(71) Applicant: Solutia Inc., St. Louis, MO (US)

(72) Inventors: Lora Lee Spangler, Belchertown, MA (US); Steven V Haldeman, Hampden, MA (US); Ingo Kramer, Herzogenrath (DE); Jeffrey B Hurlbut, West Springfield, MA (US)

(73) Assignee: Solutia Inc., St. Louis, MO (US)

(21) Appl. No.: 18/006,224

(22) PCT Filed: Jul. 22, 2021
(86) PCT No.: PCT/US2021/042738

§ 371 Date: Jan. 20, 2023

Related U.S. Application Data
(60) Provisional application No. 62/706,067, filed on Jul. 30, 2020.

(51) Int. Cl. G02B 27/01; B32B 17/10

(52) U.S. Cl. CPC G02B 27/0101; B32B 17/10678; B32B 17/10761; G02B 2027/0196; B32B 2250/05

(57) ABSTRACT

A wedge-shaped interlayer having reduced dynamic ghosting is provided, wherein the interlayer comprises at least one polymer layer comprising a poly(vinyl acetal) resin and at least one plasticizer, wherein said wedge-shaped interlayer defines a head-up display (HUD) region having a target vertical wedge angle, an actual vertical wedge angle and an absolute wedge angle rate of change, wherein the absolute wedge angle rate of change is less than 3.0 prad/mm throughout the entire HUD region.

### 1. FIELD OF THE INVENTION

This disclosure relates to polymeric interlayers and multiple layer panels, such as windshields, made with polymeric interlayers for use in head-up display applications.

### 2. DESCRIPTION OF RELATED ART

The term “laminated safety glass” generally refers to a transparent laminate that includes at least one polymer sheet, or interlayer, disposed between two sheets of glass. Laminated safety glass is often used as a transparent barrier in architectural and automotive applications, and one of its primary functions is to absorb energy resulting from an impact without allowing penetration of an object through the glass. If the force of the impact is sufficient to break the glass, the glass remains bonded to the polymeric interlayer, thereby preventing dispersion of sharp glass shards that could cause damage and injury. Laminated safety glass may also provide other benefits, such as a reduction in passage of ultraviolet (UV) and/or infrared (IR) radiation, and it may also enhance the aesthetic appearance of window openings through addition of color, texture, and the like. Additionally, safety glass with desirable acoustic properties has also been produced, which results in quieter internal spaces.

Laminated safety glass has been used in vehicles equipped with head-up display (HUD) systems. HUD systems project an image of an instrument cluster or other important information to a location on the windshield in the direct line of sight of the vehicle operator. Such a display allows the driver to stay focused on the upcoming path of travel while visually accessing dashboard, navigation, and/or safety information. When projected onto a standard windshield having uniform thickness, an interfering reflected double, or “ghost,” image is created due to the differences in the position of the projected image as it is reflected off the inner and outer surfaces of the windshield.

One method used to minimize these ghost images has been to apply a coating, such as a dielectric coating, on one of the surfaces of the windshield between the glass and the polymeric interlayer. The coating is designed to produce a third ghost image at a location very close to the primary image, while significantly reducing the brightness of the secondary image, so that the secondary image appears to blend into the background. Unfortunately, at times, the effectiveness of such coatings is limited and the coating itself may interfere with the adhesion of the polymeric interlayer to the glass substrates. This can result in optical distortion, as well as other performance issues.

Another method of reducing ghost images in windshields has been to orient the inner and outer glass panels at an angle from one another. This aligns the position of the primary reflected image off the inner panel with the secondary image reflected off the outer panel to a single point, thereby creating a single image. Typically, this is done by displacing the outer panel relative to the inner panel by employing a wedge-shaped, or “tapered,” interlayer that includes at least one region of nonuniform thickness (i.e., a wedge shape instead of a constant or uniform thickness profile). Most conventional tapered interlayers include a constant wedge angle over the entire HUD region, although some interlayers have recently been developed that include multiple wedge angles within the HUD region.

The wedge angle required to minimize the appearance of a ghost image depends on a variety of factors, including the specifics of the windshield installation, the projection system design and set up, and the position of the user. Most conventional tapered interlayers are designed and optimized for a single set of conditions unique to a given vehicle which includes an assumed driver position, including driver height, distance of the driver from windshield, and the angle at which the driver views the projected image. Some tapered interlayer designs also consider taller and shorter drivers and multiple angles to limit ghosting at all driver locations.

Additionally, while operating a vehicle, the driver's head (and/or eyes) will move within a region known as the driver's eyebox. In this eyebox area the driver is able to view the entire head up display. Head movement may be caused by the driver looking around or by eye movement, road bumps, and the like. When the position of the driver's eyes moves within the eyebox, the extent of ghosting or the relative position of the ghost image may change, get worse, or become more apparent. This is known as dynamic ghosting.

Another issue is that as technology continues to evolve, it is desirable and necessary to have a longer virtual image distance (“VID”) for at least a portion of the display field. Longer VIDs have several advantages compared to shorter VIDs. With longer VIDs, there will be less eye movement resulting in less eye fatigue, and a longer VID facilitates the overlaying of graphics onto real world objects to create an augmented-reality display.

A need exists to provide an interlayer that reduces or minimizes the amount of dynamic ghosting that is viewed when looking at an image, particularly images at longer virtual image distances. As the driver's head moves or the eyes move simply due to road conditions, the amount of ghosting may change and may become more noticeable or unacceptable.

Thus, a need exists for polymeric interlayers and windshields utilizing such interlayers that are suitable for use with HUD projection systems, and for which double image separation and dynamic ghosting is reduced.

### SUMMARY

One embodiment of the present invention relates to a wedge-shaped interlayer comprising at least one polymer layer, wherein said wedge-shaped interlayer defines a head-up display (HUD) region having a target vertical wedge angle, an actual vertical wedge angle and an absolute wedge angle rate of change, wherein the absolute wedge angle rate of change is less than 3.0 μrad/mm throughout the entire HUD region.

Another embodiment of the present invention relates to a windscreen for head-up display comprising a first glass layer, the wedge-shaped interlayer described herein.

Yet another embodiment of the present invention relates to a method of making an interlayer comprising forming an interlayer to provide a formed interlayer, wherein the formed interlayer defines a HUD region, and wherein the forming is carried out such that at least 50 percent of the HUD region of the formed interlayer has a vertical wedge angle profile that varies from the prescribed vertical wedge angle profile for the HUD region of said target interlayer by no more than 0.10 mrad; and wherein the interlayer has an absolute wedge angle rate of change, wherein the absolute wedge angle rate of change is less than 3.0 μrad/mm throughout the entire HUD region.

In embodiments, the absolute wedge angle rate of change is less than 2.9 μrad/mm, or 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, or 0.1 μrad/mm throughout the entire HUD region. In embodiments, the actual vertical wedge angle profile varies from the target vertical wedge angle profile by no more than 0.10, 0.09, 0.08, 0.07, 0.06, 0.05, 0.04, 0.03, 0.02, or 0.01 mrad.

### BRIEF DESCRIPTION OF THE DRAWINGS

Various embodiments of the present invention are described in detail below with reference to the attached drawing Figures, wherein:

FIG. 1 is a partial side view of a vehicle that includes a head-up display (HUD) system showing a typical eyebox location;

FIG. 2a is an exploded view of a windshield including an interlayer having a HUD region;

FIG. 2b is a partial cross-sectional view of the windshield depicted in FIG. 2a, taken along line A-A′;

FIG. 3 is a cross-sectional view of a tapered interlayer configured in accordance with one embodiment of the present invention, where various features of the tapered interlayer are labeled for ease of reference;

FIG. 4 is a graphical depiction of wedge angle as a function of position in the HUD region for several tapered interlayers;

FIG. 5 is a graph showing an example of a thickness profile of a tapered interlayer;

FIG. 6 is a graph showing an example of a local wedge angle profile of the tapered interlayer shown in FIG. 5;

FIG. 7 is a graph showing an example of a rate of change profile of the local wedge angle variation of the tapered interlayer shown in FIG. 5;

FIG. 8 is a schematic diagram illustrating a portion of the experimental set up for determining the reflected double image separation at various eyebox positions for a given windshield;

FIG. 9 is a schematic diagram illustrating another portion of the experimental set up for determining the reflected double image separation at various eyebox positions for a given windshield;

FIG. 10 is an example of a profile formed by analyzing a captured projection image by plotting the number of pixels for a primary and secondary image as a function of intensity;

FIG. 11 is a picture showing how primary and secondary images will be seen to a driver as the variable angle wedge deviation from target increases;

FIG. 12 is a picture showing how primary and secondary images will be seen to a driver as the virtual image distance increases and the wedge angle deviation remains constant;

FIG. 13a is a graph showing the local wedge angle profile of the PVB interlayer of Comparative Example 1;

FIG. 13b is a graph showing the rate of change profile of the local wedge angle variation of the PVB interlayer of Comparative Example 1;

FIG. 14a is a graph showing the local wedge angle profile of the PVB interlayer of Comparative Example 2;

FIG. 14b is a graph showing the rate of change profile of the local wedge angle variation of the PVB interlayer of Comparative Example 2;

FIG. 15a is a graph showing the local wedge angle profile of the PVB interlayer of Comparative Example 3;

FIG. 15b is a graph showing the rate of change profile of the local wedge angle variation of the PVB interlayer of Comparative Example 3;

FIG. 16a is a graph showing the local wedge angle profile of the PVB interlayer of Comparative Example 4;

FIG. 16b is a graph showing the rate of change profile of the local wedge angle variation of the PVB interlayer of Comparative Example 4;

FIG. 17a is a graph showing the local wedge angle profile of the PVB interlayer of Comparative Example 5;

FIG. 17b is a graph showing the rate of change profile of the local wedge angle variation of the PVB interlayer of Comparative Example 5;

FIG. 18a is a graph showing the local wedge angle profile of the PVB interlayer of Comparative Example 6;

FIG. 18b is a graph showing the rate of change profile of the local wedge angle variation of the PVB interlayer of Comparative Example 6;

FIG. 19a is a graph showing the local wedge angle profile of the PVB interlayer of Example 1;

FIG. 19b is a graph showing the rate of change profile of the local wedge angle variation of the PVB interlayer of Example 1;

FIG. 20a is a graph showing the local wedge angle profile of the PVB interlayer of Example 2; and

FIG. 20b is a graph showing the rate of change profile of the local wedge angle variation of the PVB interlayer of Example 2.

### DETAILED DESCRIPTION

The present invention generally relates to polymeric interlayers, as well as laminated windshields employing such interlayers, that can be used in a vehicle having a head-up display (HUD) system. More specifically, interlayers and windshields as described herein may be configured to minimize, or even prevent, unacceptable HUD image quality related to reflected double image separation and dynamic ghosting. Head-up display windshields employ interlayers with thicknesses optimized to minimize or eliminate reflected double image separation. Further, even when the level of ghosting may be acceptable to a driver whose head is in a fixed position, as the driver's head moves within the eyebox there can be dynamic ghosting, which is unacceptable. Dynamic ghosting, as used herein, is defined as ghosting or a ghost image that changes (i.e., gets worse such that separation distance between the primary image and the secondary image increases or varies in an objectional way) when the eyes (or head) move within the eyebox while viewing the HUD image. As used herein, the term “reflected double image separation” refers to the separation distance between the primary image and the interfering secondary, or “ghost,” image that is caused by the differences in position of the projected image when it is reflected off the inside and outside surfaces of the glass. As used herein, the term “eyebox” refers to a three-dimensional area in which the entire HUD image is viewable by at least one eye of the driver as they are seated in the vehicle in which the windshield and HUD projection system are installed. As described in further detail below, windshields having interlayers according to embodiments of the present invention minimize separation between the primary and reflected double images at longer virtual image distances, while also preventing or reducing dynamic double or ghost images. Dynamic ghosting is more likely to occur with longer virtual image distance HUD projector systems because small angular deviations can become large spatial separations when projected at long virtual image distances. By careful control of the interlayer to a certain target profile having certain criteria as described below, the dynamic ghosting may be minimized or eliminated.

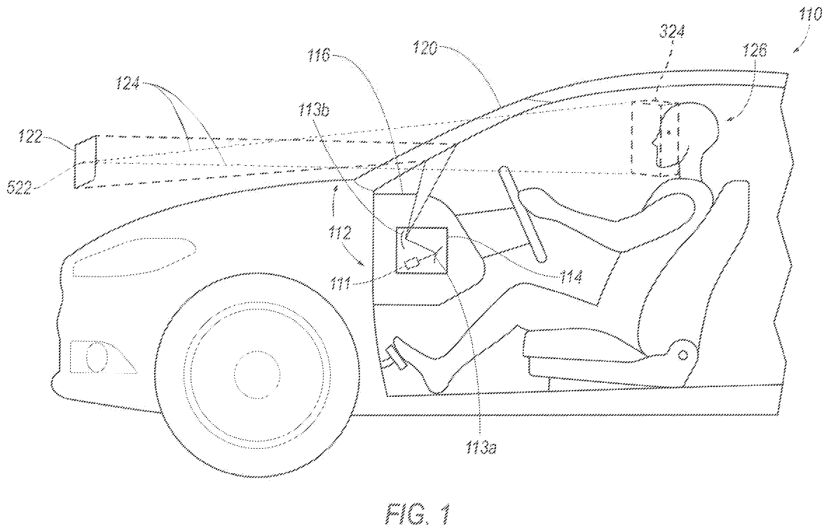

Turning initially to FIG. 1, a schematic partial view of a vehicle 110 employing a HUD system 112 is shown. HUD system 112 includes a projection assembly 114, which is mounted below the vehicle dashboard 116 and is configured to project an image onto the vehicle windshield 120. As the image is projected from the projection assembly 114 onto the windshield 120, the reflected images are collimated by the windshield 120 to create a single virtual image 122 in front of the vehicle 110. The virtual image can be projected such that it can be viewed within the eyebox 324 of the driver 126, thereby enabling the driver 126 to view the projected image 522 within the projection box 122 while simultaneously operating the vehicle 110. The distance at which the virtual image appears in front of the driver is conventionally 2 to 3 meters but can be as much as 10 meters or more. The eyebox 324 is a three-dimensional region in space in which the driver is able to view the entire virtual image display with at least one eye.

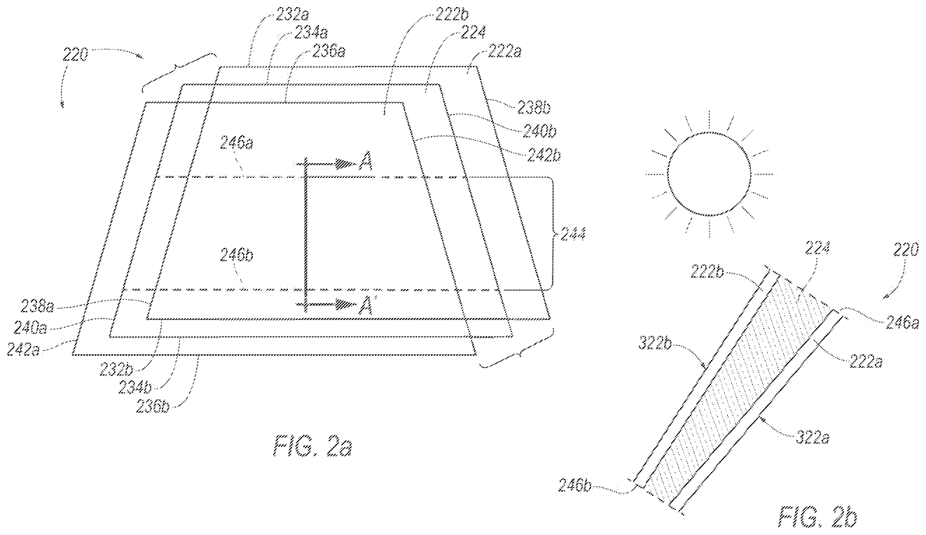

Ghost image separation (ghosting) between the primary and secondary reflected HUD images arises when the wedge angle of the interlayer (such as PVB) used to offset the angle between the inner and outer surfaces of the windshield deviates from the ideal wedge angle calculated from the windshield and projector geometry to overlap the primary reflection off surface 4 and the secondary reflection off surface 1. As shown in FIG. 2b, the primary reflection surface 322a, conventionally referred to as surface 4, is the surface closest to the driver, and the secondary reflection surface 322b, conventionally referred to as surface 1, is the surface closest to the outside of the vehicle or the sun. At longer VIDs, dynamic ghosting is more problematic or apparent to the driver because of the increased sensitivity to the variation of the wedge angle from the ideal or target value. The ghost separation distance is proportional to the wedge angle deviation from the target and the proportionality constant for a given geometrical configuration increases as the virtual image distance increases. In addition, as the wedge angle varies more from the target, the dynamic ghosting will get worse.

It is becoming desirable to increase the VID of some HUD systems. Longer VIDs provide a better user/driver experience by reducing eye fatigue, eyestrain, and headaches since there is less eye muscle movement. Longer VIDs also facilitate the “fusion” of augmented reality images with the real world and overlaying of navigation instructions directly on the road. However, for a given deviation between the ideal and actual interlayer wedge angle, the ghost image separation distance increases as VIDs increase. Therefore, to minimize ghosting and particularly dynamic ghosting at longer VIDs, the wedge angle variation from the target or ideal wedge angle must be decreased to maintain acceptable image performance.

The HUD system 112 can be any suitable type of system capable of projecting an image onto a vehicle windshield, as known to one skilled in the art. In general, suitable HUD systems utilize a system of relay optics and the reflection of the windshield to create a virtual image 122 outside the vehicle. The HUD system 112 can include a projection unit 111 configured to transmit an image amongst a plurality of mirrors, shown in FIG. 1 as 113a and 113b, and ultimately to pass the image to windshield 120. Generally, at least one of the mirrors is concave, as shown by mirror 113b in FIG. 1, in order to magnify the image for projection onto the windshield 120. The HUD system 112 may be configured in one of many different ways, and may be specifically designed for a certain vehicle according to vendor-specified installation conditions.

The HUD head motion box, or “eyebox,” 324 in FIG. 1 is a three-dimensional region in space in which the driver is able to view the entire virtual image display with at least one eye. Typically, the eyebox is slightly larger than the area encompassing the driver's eyes to allow the driver some freedom of head movement, and typically extends at least 40 to 50 mm or more above and below, at least 75 to 100 mm or more to the left and right, and at least 75 mm or more in front of and behind the center point of the driver's eyes when the driver is comfortably seated in the driver's seat. Depending on the vehicle, windscreen and installation, these numbers may vary. As used herein, the term “comfortably seated” means sitting with one's back against the driver's seat, one's foot on the pedals, and one's hands on the steering wheel as shown in FIG. 1. The HUD eyebox is designed to be as large as possible to allow maximum head motion while still being able to view all display information. Modern HUD eyebox dimensions are typically at least about 100, 150, 200 or 250 mm or more in the lateral direction, at least about 50, 55, 60, 65, 70, 75, 80, 85, 90, 95, 100, 105, 110, 115 or 120 mm or more in the vertical direction, and at least 50, 55, 60, 65, 70 or 75 mm or more in the longitudinal direction but other sizes are also possible depending on the design of the projection unit and the intended use. In embodiments, the HUD eyebox dimensions may be from about 150 to 250 mm in the lateral direction, 75 to 120 mm in the vertical direction, and at least 75 mm in the longitudinal direction.

The windshield 120 is an integral optical component of the HUD system 112 and can act as the final optical combiner for reflecting the image into the driver's field of view 124. A windshield 220 configured having a tapered interlayer as described by the invention is illustrated in FIGS. 2a and 2b. Windshield 220 may comprise a pair of glazing panels 222a,b and a polymeric interlayer 224 disposed between and in contact with each of the panels 222a,b. Although shown in FIG. 2a for clarity in an exploded view, it should be understood that interlayer 224 may be in contact with a significant portion, or all, of the interior surfaces of each of panels 222a,b when assembled to form windshield 220. Interlayer 224 may be one or more layers and/or may have additional functionality, as further described below.

Glazing panels 222a and 222b may be formed of any suitable material and can have dimensions required for any specific application. For example, in some embodiments, at least one of glazing panels 222a,b may be formed of a rigid material, such as glass, and each of the panels 222a,b may be formed from the same material or from different materials. In some embodiments, at least one of the panels 222a,b can be a glass panel, while, in other embodiments, at least one of the panels 222a,b can be formed of another material including, for example, a rigid polymer such as polycarbonate, acrylic, polyester, copolyester, and combinations thereof. Typically, neither of the panels 222a,b is formed from softer polymeric materials including elastomeric polymer materials more suitable for use in forming interlayer 224, as described in detail shortly.

In some embodiments, at least one of the panels 222a,b may comprise a glass panel. Any suitable type of glass may be used including, for example, a glass selected from the group consisting of alumina-silicate glass, borosilicate glass, quartz or fused silica glass, and soda lime glass. When used, the glass panel or panels may be annealed, thermally-treated, chemically-tempered, etched, coated, or strengthened by ion exchange, or one or both panels may have been subjected to one or more of these treatments. The glass itself may be rolled glass, float glass, or plate glass. In some embodiments, the glass may not be chemically-treated or strengthened by ion exchange, while, in other embodiments, the glass may not be an alumina-silicate glass. When both of panels 222a,b comprise glass panels, the type of glass used to form each may the same, or it may be different.

The panels 222a,b can have any suitable thickness. In some embodiments, the nominal thickness of the outboard panel 222b and/or inboard panel 222a can be at least about 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, or at least about 2.2 millimeters (mm) and/or less than about 2.9 mm, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1 or less than about 1.0 mm.

In certain embodiments, two panels 222a,b may have the same nominal thickness, which is typically referred to as a “symmetric” configuration, or one of the panels 222a,b may have a thickness different than the other panel 222b,a. This is referred to as an “asymmetric” configuration. In certain embodiments when windshield 220 includes an asymmetric configuration, outboard panel 222b, which may be configured to face the outside of the vehicle, may have a greater thickness than inboard panel 222a, which may be configured to face toward the interior of the vehicle, when windshield 220 is installed in a vehicle. In certain embodiments, windshield 220 may have an asymmetric configuration in which inboard panel 222a has a greater thickness than outboard panel 222b.

As shown in FIG. 2a, inboard panel 222a, interlayer 224, and outboard panel 222b each include an upper installed edge, shown as 232a, 234a, and 236a, respectively, and a lower installed edge, shown as 232b, 234b, and 236b, respectively. Each of the upper and lower installed edges 232a,b, 234a,b and 236a,b of respective inboard panel 222a, interlayer 224, and outboard panel 222b can be spaced apart from each other in a generally vertical direction when windshield 120 is oriented in a manner similar to when it is installed in a vehicle.

Although terms such as “upper” and “lower” are relative, such terms, as used herein, are modified with “as installed” or “installed,” which refers to the relative position of a component or item when a windshield including the component or item is oriented as it would be when installed in a vehicle. Therefore, the “upper installed edge” and the “lower installed edge” respectively refer to the upper and lower edges of the windshield when the windshield 220 is oriented as it would be when installed in a vehicle.

As shown in FIG. 2a, inboard panel 222a, interlayer 224, and outboard panel 222b each include a driver side installed edge 238a, 240a, and 242a, respectively, and a passenger side installed edge 238b, 240b, and 242b, respectively. The driver side installed edge of each of inboard panel 222a, interlayer 224, and outboard panel 222b can be spaced apart from the corresponding passenger side installed edge 238b, 240b, and 242b in a generally horizontal direction when the windshield 220 is oriented as it would be when installed in a vehicle. Although referred to herein as the “driver side” and the “passenger side,” it should be understood that the actual location of the driver and passenger may be reversed, depending on the country in which the vehicle employing the windshield is operated. These terms are used herein as a point of reference, and should not be construed as being unnecessarily limiting.

Additionally, as shown in FIG. 2a, each of driver side installed edges 238a, 240a, and 242a and passenger side installed edges 238b, 240b, and 242b of inboard panel 222a, interlayer 224, and outboard panel 222b intersect respective upper installed edges 232a, 234a, and 236a and lower installed edges 232b, 234b, and 236b at the corners of inboard panel 222a, interlayer 224, and outboard panel 222b, respectively. One or more of the driver side installed edges 238a, 240a, and 242a and/or one of the of one or more of the passenger side installed edges 238b, 240b, and 242b may be oriented at an angle with respect to the upper installed edges 232a, 234a, and 236a and/or lower installed edges 232b, 234b, and 236b of inboard panel 222a, interlayer 224, and outboard panel 222b. As a result, one or more of upper installed edges 232a, 234a, or 236a may be shorter than its corresponding lower installed edge 232b, 234b, or 236b. Additionally, although not depicted in FIG. 2a, the windshield may also be curved in one or more regions, and can, in some cases, have a complex curvature that changes in both the horizontal and vertical directions.

In certain embodiments, the length of at least one of upper installed edges 232a, 234a, and 236a of inboard panel 222a, interlayer 224, and outboard panel 222b may be at least about 500, at least about 650, at least about 750, at least about 850, at least about 950, at least about 1000 mm and/or not more than about 2500, not more than about 2000, not more than about 1500, not more than about 1250 mm, measured from the intersection of driver side installed edge 238a, 240a, or 242a with one end of upper installed edge 232a, 234a, or 236a to the intersection of passenger side edge 238b, 240b, or 242b with the other end of upper installed edge 232a, 234a, or 236a.

In certain embodiments, the length of at least one of lower installed edges 232b, 234b, and 236b of inboard panel 222a, interlayer 224, and outboard panel 222b may be at least about 750, at least about 900, at least about 1000, at least about 1250, or at least 1400 mm and/or not more than about 2500, not more than about 2250, not more than about 2000, not more than about 1850 mm, measured from the intersection of driver side installed edge 238a, 240a, or 242a with one end of lower installed edge 232b, 234b, or 236b to the intersection of passenger side edge 238b, 240b, or 242b with the other end of lower installed edge 232b, 234b, or 236b. Other sizes are also possibly depending on the desired application and design.

Further, in some embodiments, windshield 220 may have a curved lower region extending downwardly from lower installed edge 232b, 234b, and 236b of inboard panel 222a, interlayer 224, and outboard panel 222b. In such embodiments, the radius of curvature at the furthest point of the curved lower region from the lower installed edge 232b, 234b, or 236b can be at least 100, at least about 150, at least about 175, or at least about 200 mm and/or not more than about 325, not more than about 300, not more than about 275, not more than about 250, or not more than about 225 mm. However, exact dimensions of any of the lengths may depend on the ultimate use of the windshield 220, and may vary outside the above ranges.

As shown in FIGS. 2a and 2b, the interlayer 224 may define a HUD region 244 that includes at least one region of nonuniform thickness. As particularly shown in FIG. 2b, when laminated between outboard panel 222b and inboard panel 222a, the HUD region 244 (defined by 246a and 246b) of interlayer 224 may cause the outboard panel 222b to be oriented at a slight angle from the inboard panel 222a. The exact angle of orientation depends on the specific wedge profile of the interlayer 224, as further discussed below.

As shown in FIG. 2a, the HUD region 244 of interlayer 224 may be defined by an upper installed HUD boundary 246a and a lower installed HUD boundary 246b. As discussed previously, the upper and lower installed HUD boundaries 246a,b can be spaced from one another in a generally vertical direction when windshield 220 is oriented in a manner similar to when it is installed in a vehicle. Upper and lower installed HUD boundaries 246a,b can also be substantially parallel to respective upper and lower installed edges 234a,b of interlayer 224. As used herein the term “substantially parallel” means within about 5° of being parallel. In some embodiments, upper and lower installed HUD boundaries 246a,b can also be within about 3°, within about 2°, or within about 1° of being parallel to respective upper and lower installed edges 234a,b of interlayer 224.

As shown in FIG. 2a, the lower HUD installed boundary 246b can be spaced from the lower installed edge 234b of interlayer 224 along the height of the windshield 220 when windshield 220 is oriented in a manner similar to when it is installed in a vehicle. As used herein, the term “height” refers to the second largest dimension of the windshield 220, when it is oriented as it would be when installed in a vehicle. The height of windshield 220 can be defined between, for example, upper and lower installed edges 232a,b, 234a,b, and 236a,b of inboard panel 222a, interlayer 224, and outboard panel 222b, respectively. Similarly, the “width” is the largest dimension of the windshield, and may be defined between the driver side and passenger side installed edges 238a,b, 240a,b, and 242a,b of inboard panel 222a, interlayer 224, and outboard panel 222b, respectively. Additionally, the “thickness” of the windshield 220 is the smallest dimension and may be the combined thicknesses of inboard panel 222a, interlayer 224, and outboard panel 222b, when each are laminated together to form windshield 220.

As shown in FIG. 2a, the lower HUD installed boundary 246b can be positioned between and may be generally parallel to upper installed edge 234a and lower installed edge 234b of interlayer 224. For example, lower HUD installed boundary 246b may be spaced from the lower installed edge 234b of interlayer 224 by a distance of at least about 150, at least about 200, at least about 225, at least about 250, at least about 275, at least about 300, at least about 350, at least about 400 mm, at least about 425 mm, at least about 450 mm, at least about 475 mm, or at least about 500 mm or more. The upper HUD installed boundary 246a and the upper installed edge 234a of the interlayer 224 can be spaced apart from each other, along the height of the interlayer 224, by at least about 125, at least about 150, at least about 175, at least about 200, at least about 225, at least about 250, at least about 275, or at least about 300 mm, or the upper HUD installed boundary 246a can coincide with the upper installed edge 234a of the interlayer 224.

The total height of the HUD zone 244, measured between the upper and lower HUD installed boundaries 246a,b in a direction parallel to the height of the interlayer, can be at least about 100, 125, 150, 175, 200, 225, 250, 275, 300, 325, 350, 375, 400, 425, 450, 475, or at least about 500 mm and/or extend from the lower HUD installed boundary 246b to the upper installed edge 234a of the interlayer 224. The total height of the HUD zone 244 may be consistent along the width of the interlayer 224, or the height may be different in one or more regions of the HUD zone than it is in one or more other regions of the HUD zone. In some embodiments, at least about 15, at least about 20, at least about 25, at least about 30, at least about 35, at least about 40, at least about 45 and/or not more than about 75, not more than about 70, not more than about 65, or not more than about 60 percent of the total length of a line drawn between and perpendicular to each of the upper installed edge 234a and the lower installed edge 234b of the interlayer 224 may fall within the HUD region 244 of interlayer 224.

The HUD region 244 may extend across a portion, or all, of the total width of the interlayer 224. In some embodiments, the upper and/or lower HUD Installed boundary may extend at least about 30, at least about 40, at least about 50, at least about 55, at least about 60, at least about 65, at least about 70, at least about 75, at least about 85, or at least about 90 percent of the total distance between the driver side installed edge 240a and the passenger side installed edge 240b of interlayer 224. In some embodiments, as shown in FIG. 2a, the HUD region 244 may extend across the entirety of the interlayer 224, such that upper HUD installed boundary 246a and lower HUD installed boundary 246b each intersect the driver side installed edge 240a and the passenger side installed edge 240b of interlayer 224, as shown in FIG. 2a.

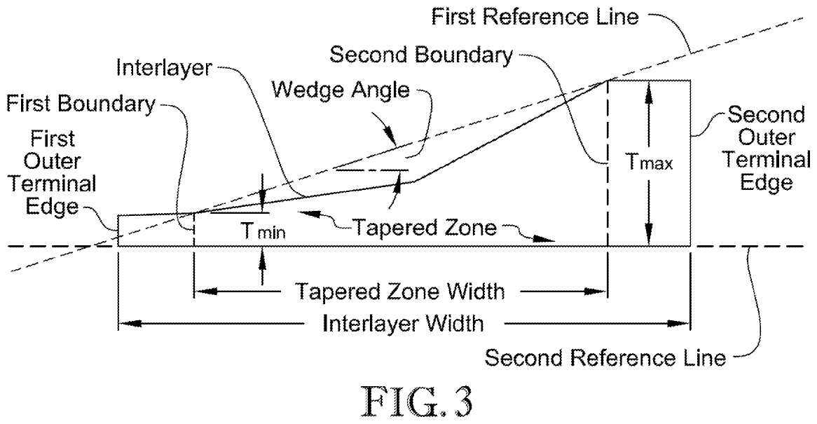

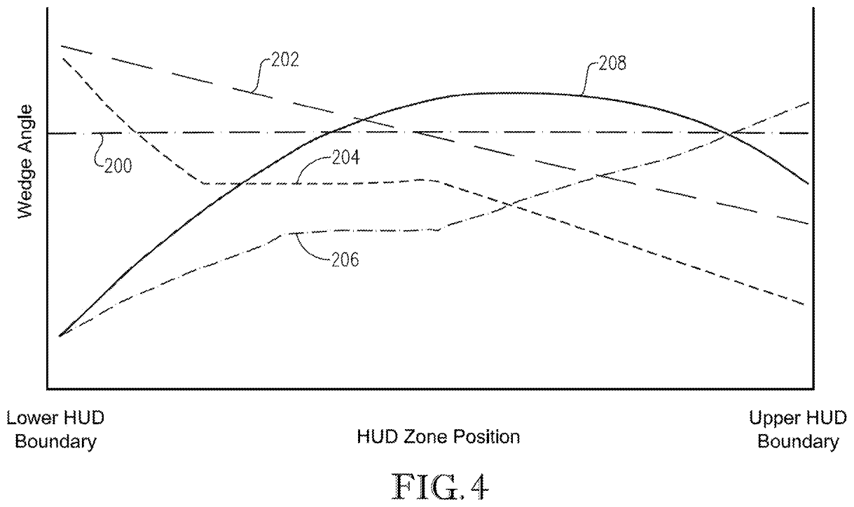

Turning now to FIGS. 3 and 4, several embodiments of interlayers having an at least partially tapered thickness profile and wedge angle profiles are provided. FIG. 3 is a cross-sectional view of a tapered interlayer that includes a tapered zone of varying thickness. As shown in FIG. 3, the tapered zone has a minimum thickness, Tₘᵢₙ, measured at a first boundary of the tapered zone and a maximum thickness, Tₘₐₓ, measured at a second boundary of the tapered zone. In certain embodiments, Tₘᵢₙ can be at least about 0.15, 0.20, 0.25, 0.30, 0.35, 0.40, 0.45, 0.50, 0.55, or at least about 0.60 mm and/or not more than 1.2, not more than about 1.1, or not more than about 1.0 mm. In certain embodiments, Tₘₐₓ can be at least about 0.38, at least about 0.53, or at least about 0.76 mm and/or not more than 2.2, not more than about 2.1, or not more than about 2.0 mm. In certain embodiments, the difference between Tₘₐₓ and Tₘᵢₙ can be at least about 0.13, at least about 0.15, at least about 0.20, at least about 0.25, at least about 0.30, at least about 0.35, at least about 0.40 mm and/or not more than 1.2, not more than about 0.90, not more than about 0.85, not more than about 0.80, not more than about 0.75, not more than about 0.70, not more than about 0.65, or not more than about 0.60 mm. In certain embodiments, the distance between the first and second boundaries of the tapered zone (i.e. the “tapered zone width”) can be at least about 5, at least about 10, at least about 15, at least about 20, or at least about 30 centimeters (cm), or up to the full “interlayer width”.

As shown in FIG. 3, the tapered interlayer includes opposite first and second outer terminal edges. In the embodiment depicted in FIG. 3, the first and second boundaries of the tapered zone are spaced inwardly from the first and second outer terminal edges of the interlayer. In such embodiments, only a portion of the interlayer is tapered. When the tapered zone forms only a portion of the interlayer, the ratio of the tapered zone width to the interlayer width can be at least about 0.05:1, at least about 0.10:1, at least about 0.20:1, at least about 0.30:1, at least about 0.40:1 at least about 0.50:1, at least about 0.60:1, or at least about 0.70:1 and/or not more than about 1:1, not more than about 0.95:1, not more than about 0.90:1, not more than about 0.80:1, or not more than about 0.70:1. In an alternative embodiment, discussed below, the entire interlayer is tapered. When the entire interlayer is tapered, the tapered zone width can be equal to the interlayer width and the first and second boundaries of the tapered zone are located at the first and second terminal edges, respectively.

As illustrated in FIG. 3, the tapered zone of the interlayer can have a wedge angle (e), which is defined as the angle formed between a first reference line extending through two points of the interlayer where the first and second tapered zone boundaries intersect a first (upper) surface of the interlayer and a second reference line extending through two points where the first and second tapered zone boundaries intersect a second (lower) surface of the interlayer. The term “global wedge angle” may be used interchangeably with the wedge angle (⊖) as defined herein. In certain embodiments, the tapered zone can have at least one wedge angle of at least about 0.10, at least about 0.13, at least about 0.15, at least about 0.20, at least about 0.25, at least about 0.30, at least about 0.35, or at least about 0.40 milliradians (mrad) and/or not more than about 1.2, not more than about 1.0, not more than about 0.90, not more than about 0.85, not more than about 0.80, not more than about 0.75, not more than about 0.70, not more than about 0.65, or not more than about 0.60 mrad.

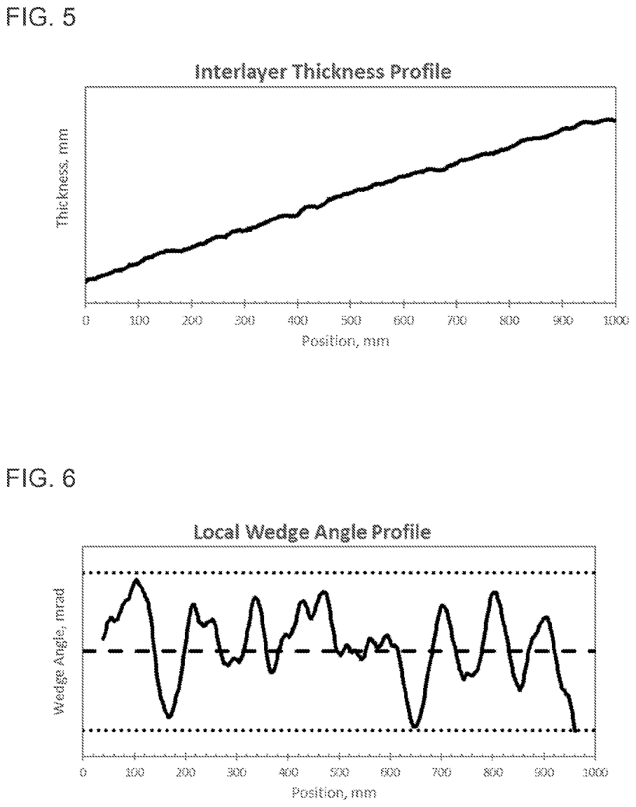

When the first and second surfaces of the tapered zone are each planar, the wedge angle of the tapered zone can be defined as the angle between the first (upper) and second (lower) surfaces. However, as discussed in further detail below, in certain embodiments, the tapered zone can include at least one variable μangle zone having a curved thickness profile and a continuously varying wedge angle. Further, in certain embodiments, the tapered zone can include two or more constant angle zones, where the constant angle zones each have a linear thickness profile, but at least two of the constant angle zones have different wedge angles. FIG. 5 shows an example of a wedge angle profile increasing over the entirety of the HUD region.

Referring now to FIG. 4, some example wedge angle profiles for various tapered interlayers are shown. A wedge angle profile is a graphical depiction of the wedge angle of an interlayer as a function of position within the HUD region. The wedge angle profile of a tapered interlayer may increase, decrease, and/or remain constant over at least a portion of the HUD region. In certain embodiments, the wedge angle profile may increase over at least a portion of the HUD region. Examples of this type of wedge angle profile are shown by lines 206 and 208 in FIG. 4. When at least a portion of the wedge angle profile increases, at least a portion may also remain constant (as shown by line 206), or a portion of the profile may also decrease (as shown by line 208). In some embodiments (not shown), the wedge angle profile may increase over the entirety of the HUD region.

In certain embodiments, the wedge angle profile may decrease over at least a portion of the HUD region. Examples of this type of wedge angle profile are shown by lines 202 and 204 in FIG. 4. When at least a portion of the wedge angle profile of an interlayer decreases, the wedge angle profile may also increase (not shown) and/or remain constant (as shown by line 204) over a portion of the HUD region. In certain embodiments (shown by line 202), the wedge angle may decrease over the entirety of the HUD region. In certain embodiments, the wedge angle profile may remain constant over at least a portion of the HUD region, or over its entirety as shown by line 200 in FIG. 4. Interlayers having other combinations of regions of increasing, decreasing, and constant wedge angles are also possible.

In practice, the thickness profiles of real polymeric interlayer sheets which create the wedge angles intended to eliminate ghosting do not perfectly match the targeted thickness profiles calculated to completely eliminate ghost images. This results in real-world interlayers which contain small localized thickness deviations that result in similarly small localized wedge angle variations above and below the target wedge angle in the HUD zone, consisting of both positive and negative deviations. As a driver's head and eyes move within the HUD eyebox, the eyes view slightly different positions on the windshield in the HUD zone which have different localized wedge angles. This may result in different amounts of ghost image separation or ghosting. As previously stated, this change in the ghost image separation over short distances as the head and/or eye position moves is referred to as “dynamic ghosting”.

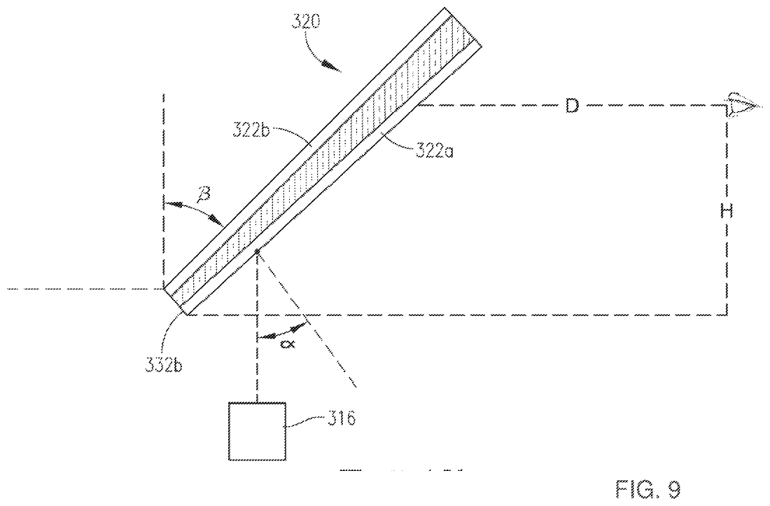

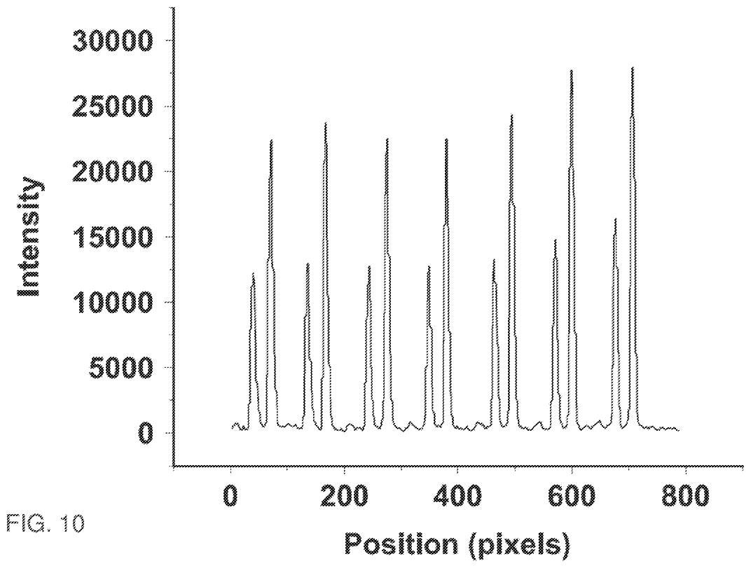

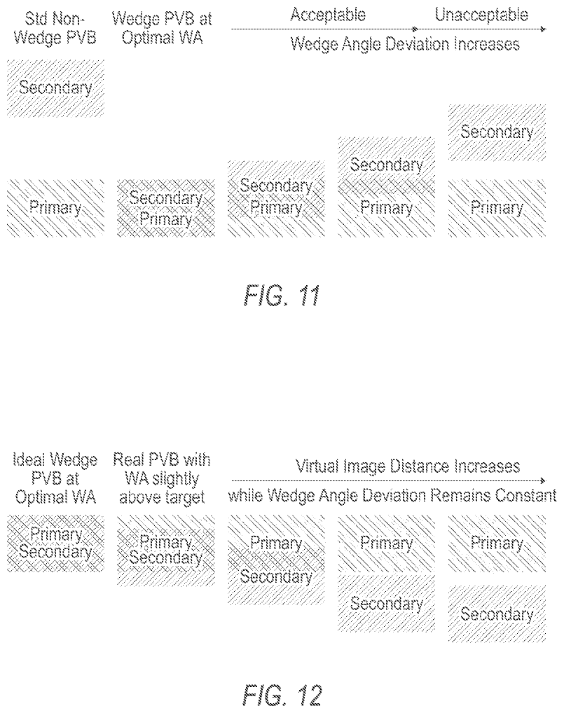

In a tapered interlayer, the magnitude of the ghost image separation is proportional to the wedge angle deviation from target in that location, and the secondary (or ghost) image will vary above and below the primary image depending on whether the actual local wedge angle is less than or greater than the ideal target wedge angle. FIGS. 11 and 12 show different embodiments of how the primary and secondary images are perceived by a driver looking through a windshield. If a standard flat (non-wedge or non-tapered) interlayer and windshield are used, there will be a relatively large separation between the primary and secondary images due to the misalignment of the images from the different surfaces. As previously described, when a tapered interlayer is used, at the optimal or target wedge angle, the primary and secondary images will align (i.e., essentially will appear to overlap each other) and there will be substantially no separation between the images. Since the wedge angle of the interlayer is not always at the optimal or target wedge angle, there may be some separation, but the separation will be minimized and generally considered acceptable. As shown in FIG. 11, when the virtual image distance remains constant, the ghost image separation distance increases and the ghost image becomes more visible as the deviation from the optimal or target wedge angle increases, as shown by the primary and secondary images getting further apart from one another as VID increases.

Similarly, for a real interlayer with a small local deviation from the target wedge angle, the perceived ghost image separation distance will increase as the virtual image distance increases. This is depicted in FIG. 12, which shows how the separation distance between the primary and secondary images increases at longer VIDs, even when the wedge angle deviation from target remains constant. Therefore, a small deviation from the target wedge angle which may be acceptable at small or short VIDs can result in the driver experiencing larger, objectionable ghost image separation at longer VIDs. In addition, because the ghosting is more visible or noticeable at longer VIDs, localized variation of the wedge angle is more problematic because it leads to more objectionable dynamic ghosting at longer VIDs. It is therefore important to further minimize this ghosting or image separation at longer virtual image distances.

To quantify and limit the amount of dynamic ghosting that a driver experiences, it is necessary to define the absolute magnitude and the rate of change of the wedge angle variation from the target wedge angle which eliminates ghosting over a typical viewing distance as seen from the driver's eyebox. If the rate of change of the wedge angle variation is too great, the dynamic ghosting will be objectionable. In embodiments, the absolute wedge angle variation from target is less than 0.1 mrad and the 50 mm rate of change of the wedge angle is less than 4 μrad per millimeter (that is, from −4 μrad/mm to +4 μrad/mm), less than 3, less than 2, or less than 1 μrad/mm (−1 μrad/mm to +1 μrad/mm).

FIG. 5 depicts a thickness profile of an actual wedge interlayer for use in the windscreen of a HUD system. FIG. 6 depicts the plot of the actual local wedge angle variation from target of the wedge interlayer of FIG. 5. On the Y axis, the deviation from target is plotted, and the ideal case of 0.00 mrad deviation (no variation) is shown on FIG. 6 as a dashed line conforming to the equation y=θ, where θ is the target wedge angle. The curve shows how the actual wedge angle of a typical wedged interlayer varies above and below the target wedge angle over a distance of approximately 900 millimeters.

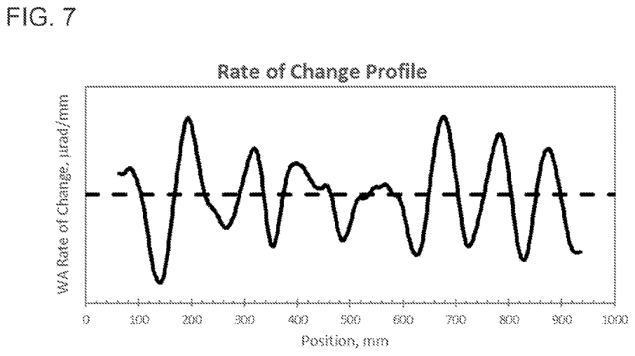

FIG. 7 is a plot of the rate-of-change of the local wedge angle deviation of the wedge interlayer depicted in FIG. 6. To calculate the rate of change, a point-by-point linear regression slope over a 50 mm span (+/−25 mm from each point) is calculated from the local wedge angle data plotted in FIG. 6 and plotted against the same positional axis. A 50 mm span is chosen as it generally corresponds with a typical range of motion that may occur by a viewer of the head-up display within a typical HUD eyebox region. On the Y axis, the rate of change of the local wedge angle deviation is plotted, and the ideal case of 0.0 μrad/mm is shown as a dashed line conforming to the equation y=0. The curve shows how the actual wedge angle rate of change of a typical wedged interlayer varies above and below zero over a distance of approximately 900 millimeters. In embodiments, the rate of change should be less than 4 μrad/mm, less than 3.5, 3.0, 2.5, 2.0, 1.5, 1.0 or less than 0.5 μrad/mm, or as close to 0.0 μrad/mm as possible.

In certain embodiments, the interlayer used to form a windshield as described herein may be a single layer, or monolithic, interlayer. In certain embodiments, the interlayer may be a multiple layer interlayer comprising at least a first polymer layer and a second polymer layer. When the interlayer is a multiple layer interlayer, it may also include a third polymer layer such that the second polymer layer is adjacent to and in contact with each of the first and third polymer layers, thereby sandwiching the second polymer layer between the first and third polymer layers. As used herein, the terms “first,” “second,” “third,” and the like are used to describe various elements, but such elements should not be unnecessarily limited by these terms. These terms are only used to distinguish one element from another and do not necessarily imply a specific order or even a specific element. For example, an element may be regarded as a “first” element in the description and a “second” element in the claims without being inconsistent. Consistency is maintained within the description and for each independent claim, but such nomenclature is not necessarily intended to be consistent therebetween. Such three-layer interlayers may be described as having at least one inner “core” layer sandwiched between two outer “skin” layers. In certain embodiments, the interlayer may include more than three, more than four, or more than five polymer layers. As used herein, the terms “core”, “skin”, “first”, “second”, “third”, and the like do not impart any limitations on the thicknesses or relative thicknesses of each layer.

Each polymer layer of the interlayer may include one or more polymeric resins, optionally combined with one or more plasticizers, which have been formed into a sheet by any suitable method. One or more of the polymer layers in an interlayer may further include additional additives, although these are not required. The polymeric resin or resins utilized to form an interlayer as described herein may comprise one or more thermoplastic polymer resins. When the interlayer includes more than one layer, each layer may be formed of the same, or of a different, type of polymer.

Examples of polymers suitable for forming the interlayer can include, but are not limited to, poly(vinyl acetal) polymers, polyurethanes (PU), poly(ethylene-co-vinyl) acetates (EVA), poly(vinyl chlorides) (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and ionomers thereof, derived from any of the previously-listed polymers, and combinations thereof. In some embodiments, the thermoplastic polymer can be selected from the group consisting of poly(vinyl acetal) resins, poly(vinyl chloride), poly(ethylene-co-vinyl) acetates, and polyurethanes, while in other embodiments, the polymer can comprise one or more poly(vinyl acetal) resins. Although generally described herein with respect to poly(vinyl acetal) resins, it should be understood that one or more of the above polymers could be included in addition to, or in the place of, the poly(vinyl acetal) resins described below in accordance with various embodiments of the present invention.

When the polymer used to form interlayer includes a poly(vinyl acetal) resin, the poly(vinyl acetal) resin may include residues of any aldehyde and, in some embodiments, may include residues of at least one C₄ to C₈ aldehyde. Examples of suitable C₄ to C₈ aldehydes can include, for example, n-butyraldehyde, i-butyraldehyde, 2-methylvaleraldehyde, n-hexyl aldehyde, 2-ethylhexyl aldehyde, n-octyl aldehyde, and combinations thereof. In certain embodiments, the poly(vinyl acetal) resin may be a poly(vinyl butyral) (PVB) resin that primarily comprises residues of n-butyraldehyde. Examples of suitable types of poly(vinyl acetal) resins are described in detail in U.S. Pat. No. 9,975,315 B2, the entirety of which is incorporated herein by reference to the extent not inconsistent with the present disclosure.

In certain embodiments, the interlayer may include one or more polymer films in addition to one or more polymer layers present in the interlayer. As used herein, the term “polymer film” refers to a relatively thin and often rigid polymer that imparts some sort of functionality or performance enhancement to the interlayer. The term “polymer film” is different than a “polymer layer” or “polymer sheet” as described herein, in that polymer films do not themselves provide the necessary penetration resistance and glass retention properties to the multiple layer panel, but, rather, provide other performance improvements, such as infrared absorption or reflection character.

In certain embodiments, poly(ethylene terephthalate), or “PET,” may be used to form a polymer film and, ideally, the polymer films used in various embodiments are optically transparent. The polymer films suitable for use in certain embodiments may also be formed of other materials, including various metallic, metal oxide, or other non-metallic materials and may be coated or otherwise surface-treated. The polymer film may have a thickness of at least about 0.012, 0.015, 0.020, 0.025, 0.030, 0.035, 0.040, 0.045 mm, or at least about 0.050 mm or more.

According to some embodiments, the polymer film may be a re-stretched thermoplastic film having specified properties, while, in other embodiments, the polymer film may include a plurality of nonmetallic layers that function to reflect infrared radiation without creating interference, as described, for example, in U.S. Pat. No. 6,797,396, which is incorporated herein by reference to the extent not inconsistent with the present disclosure. In certain embodiments, the polymer film may be surface treated or coated with a functional performance layer in order to improve one or more properties of the film, including adhesion or infrared radiation reflections. Other examples of polymer films are described in detail in PCT Application Publication No. WO88/01230 and U.S. Pat. Nos. 4,799,745, 4,017,661, and 4,786,783, each of which is incorporated herein by reference to the extent not inconsistent with the present disclosure. Other types of functional polymer films can include, but are not limited to, IR reducing layers, holographic layers, photochromic layers, electrochromic layers, antilacerative layers, heat strips, antennas, solar radiation blocking layers, decorative layers, and combinations thereof.

Additionally, at least one polymer layer in the interlayers described herein may include one or more types of additives that can impart particular properties or features to the polymer layer or interlayer. Such additives can include, but are not limited to, dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB₆), indium tin oxide and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers. Additionally, various adhesion control agents (“ACAs”) can also be used in one or more polymer layers in order to control the adhesion of the layer or interlayer to a sheet of glass. Specific types and amounts of such additives may be selected based on the final properties or end use of a particular interlayer and may be employed to the extent that the additive or additives do not adversely affect the final properties of the interlayer or windshield utilizing the interlayer as configured for a particular application.

According to some embodiments, interlayers as described herein may be used to form windshields that exhibit desirable acoustic properties, as indicated by, for example, the reduction in the transmission of sound as it passes through (i.e., the sound transmission loss of) the laminated panel. In certain embodiments, windshields formed with interlayers as described herein may exhibit a sound transmission loss at the coincident frequency, measured according to ASTM E90 at 20° C., of at least about 34, at least about 34.5, at least about 35, at least about 35.5, at least about 36, at least about 36.5, or at least about 37 dB or more.

The overall average thickness of the interlayer can be at least about 10, at least about 15, at least about 20, at least about 25, at least about 30, or at least about 35 mils and/or not more than about 100, not more than about 90, not more than about 75, not more than about 60, not more than about 50, not more than about 45, not more than about 40, not more than about 35, not more than about 32 mils, although other thicknesses may be used as desired, depending on the particular use and properties of the windshield and interlayer. If the interlayer is not laminated between two substrates, its average thickness can be determined by directly measuring the thickness of the interlayer using a caliper, or other equivalent device. If the interlayer is laminated between two substrates, its thickness can be determined by subtracting the combined thickness of the substrates from the total thickness of the multiple layer panel.

Interlayers used to form windshields as described herein can be formed according to any suitable method. Exemplary methods can include, but are not limited to, solution casting, compression molding, injection molding, melt extrusion, melt blowing, and combinations thereof. Multilayer interlayers including two or more polymer layers may also be produced according to any suitable method such as, for example, co-extrusion, blown film, melt blowing, dip coating, solution coating, blade, paddle, air-knife, printing, powder coating, spray coating, lamination, and combinations thereof.

When the interlayer is formed by an extrusion or co-extrusion process, one or more thermoplastic resins, plasticizers, and, optionally, one or more additives as described previously, can be pre-mixed and fed into an extrusion device. The extrusion device can be configured to impart a particular profile shape to the thermoplastic composition in order to create an extruded sheet. The extruded sheet, which is at an elevated temperature and highly viscous throughout, can then be cooled to form a polymeric sheet. Once the sheet has been cooled and set, it may be cut and rolled for subsequent storage, transportation, and/or use as an interlayer.

Co-extrusion is a process by which multiple layers of polymer material are extruded simultaneously. Generally, this type of extrusion utilizes two or more extruders to melt and deliver a steady volume throughput of different thermoplastic melts of similar or different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

In certain embodiments, the interlayers used to form windshields as described herein may be produced such that the interlayer has a wedge angle that deviates from a (target/optimal) predetermined, or prescribed, wedge angle profile for a target interlayer by no more than 0.10, 0.095, 0.09, 0.085, 0.08, 0.075, 0.07, 0.065, 0.06, 0.055, or no more than 0.05 mrad over at least about 50, at least about 60, at least about 70, at least about 80, or at least about 90 percent of the HUD region. In certain embodiments, the wedge angle profile of the formed interlayer may deviate from the predetermined wedge angle profile by no more than 0.10, 0.095, 0.09, 0.085, 0.08, 0.075, 0.07, 0.065, 0.06, 0.055, or no more than 0.05 mrad over the entire HUD region.

In certain embodiments, the interlayers used to form windshields as describe herein may be produced such that the interlayer has a wedge angle rate of change profile that deviates from zero by no more than 4.0, 3.5, 3.0, 2.5, 2.0, 1.5, 1.0 or no more than 0.5 μrad/mm over a portion of or the entire HUD region.

The target wedge angle profile or target thickness profile may be provided by, for example, a third party vendor, such as a laminator, a HUD system vendor, or a vehicle manufacturer, or it may be otherwise determined. In some embodiments, the measured wedge angle profile for a formed interlayer may vary slightly in shape from the target profile, but may still exhibit a maximum variation from the target wedge angle profile within the above ranges. The wedge angle and wedge angle rate of change of the formed interlayer may be measured as described below.

Windshields and other types of multiple layer panels may be formed from the interlayers and glazing panels as described herein by any suitable method. The typical glass lamination process comprises the following steps: (1) assembly of the two substrates and the interlayer; (2) heating the assembly via an IR radiant or convective device for a first, short period of time; (3) passing the assembly into a pressure nip roll for the first de-airing; (4) heating the assembly for a short period of time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperature between 135° C. and 150° C. and pressures between 150 psig and 200 psig for about 30 to 90 minutes. Other methods for de-airing the interlayer-glass interface, as described according to one embodiment in steps (2) through (5) above include vacuum bag and vacuum ring processes, and both may also be used to form windshields and other multiple layer panels as described herein.

As previously described, windshields configured according to certain embodiments of the present invention are designed to minimize reflected double image separation for drivers, while also minimizing dynamic ghosting. In contrast to other windshields used in HUD applications, which are typically optimized for shorter VIDs, windshields of the present invention may exhibit little or no double image separation at longer VIDs. An example of the double image separation is shown in FIG. 12, as previously described. As shown in FIG. 12, windshields with standard (non-wedge or non-tapered) interlayers have a large separation between the primary and secondary images, while windshields configured with wedge interlayers at the target wedge angle minimize reflected double image separation. As the actual wedge angle deviates from the optimal or target wedge angle, the reflected double image separation distance increases. At longer VIDs, this separation can be even more problematic as previously described due to dynamic ghosting. Windshields using interlayers according to embodiments of the present invention minimize reflected double image separation and dynamic ghosting at longer VIDs, providing drivers with a clearer and more readable virtual image in real-world driving situations. In certain embodiments, windshields configured as described herein may exhibit reduced reflected double image separation distance and reduced or minimized levels of dynamic ghosting in the eyebox or HUD area of the windshield.

In certain embodiments, windshields as described herein can have reduced dynamic ghosting or double image separation distances at longer VIDs when measured at standard installation conditions for that windshield. The windshields may also have reduced reflected double image separation distances when the variation from the target or optimal wedge angle is controlled to be less than a certain amount (such as less than about 0.10 mrad), as previously described.

The reflected double image separation distances are determined according to the procedure described below. The standard installation conditions for a given windshield must be determined in order to measure the upper and lower eyebox reflected double image separation distances for that windshield. As used herein, the term “standard installation conditions” refer to the installation conditions for a given windshield under which a nominal height driver observes the minimum reflected double image separation distance for that windshield. In certain embodiments, the minimum or acceptable reflected double image separation distance at standard installation conditions can be less than about 1.5, less than about 1, less than about 0.75, less than about 0.5, or less than about 0.25 arc-min, measured as described below.

If the standard installation conditions of a windshield, including how it is oriented with respect to a HUD projection system, are known, the windshield and HUD projection system may be arranged in an experimental set up according to the known installation conditions. Such installation conditions may be provided by a vendor, or another third party, may be directly measurable from a vehicle, or may be accessible in reference material related to the make and design of the vehicle.

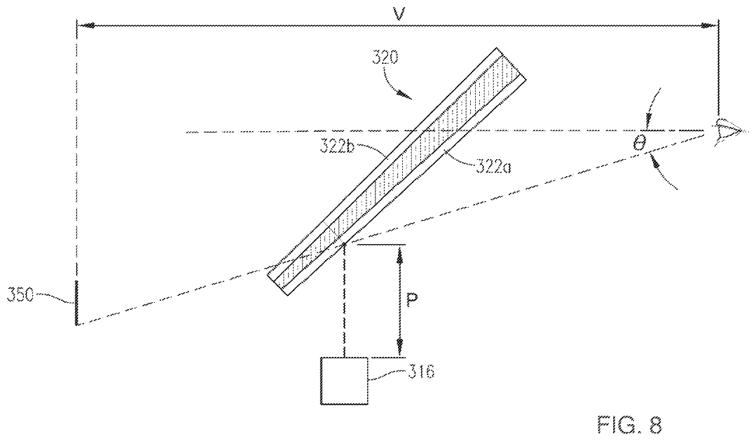

Referring to FIGS. 8 and 9, the double image separation distance of windshield 320 can be determined according to the following procedure. A projection image can be generated by passing light from the HUD projection system 316 through the windshield 320 when windshield 320 and projection system 316 are oriented as generally shown in FIGS. 8 and 9. The light passing through the windshield 320 includes an image such as, for example, a line, a shape, a picture, or a grid. Once light has passed through and is reflected off the surfaces of the windshield 320, the virtual image can be viewed through the windshield 320. The projected image may be then captured using a digital camera or other suitable device, positioned with the center line of the camera lens positioned at the centerline of the eyebox. For determination of the standard windshield installation conditions, for example, the center line of the camera lens would be positioned at a height H as shown in FIG. 9. The resulting image captured by the camera may then be digitized to form a digital projection image comprising a plurality of pixels.

Once digitized, captured images can be quantitatively analyzed to form a profile that includes at least one primary image indicator and at least one secondary image indicator. The analyzing may be performed by converting at least a portion of the digital projection image to a vertical image matrix that includes a numerical value representing the intensity of pixels in that portion of the image. A column of the matrix can then be extracted and graphed against pixel number, as shown in FIG. 10, to provide the profile. The primary image indicator on the profile can then be compared with the secondary image indicator on the profile to determine a difference. In some embodiments, the primary image indicator may comprise the higher intensity peaks of the graph, while the secondary image indicator may be the lower intensity peaks. Any suitable difference between the two indicators can be determined and, in some embodiments, can be the difference in position between the two indicators in the profile graph.

Based on the difference, the separation distance, in pixels, between the primary and secondary peaks can then be used to calculate the double image separation distance (D₁) for each panel, in milliradians (mrad), according to the following equation:

$${D}_{1} = 1 \; 000 \times \frac{peak separation ( pixels ) \times \frac{mm}{pixel}}{Virtual Image distance ( mm )}$$

The above equation is based on the small angle approximation, which, for a small angle θ, tan θ=θ, so that the double image separation distance in mm divided by the virtual image distance in mm is equal to the separation angle (D₁) in radians. The ratio of mm/pixel may be determined by calculation from a calibration image. Once the camera is positioned, the driver distance, D, and look down angle, Φ, can be calculated. Then the reflected double image separation distance can be determined.

Once formed, the vertical wedge angle profile within the HUD regions of a windshield can be directly measured using an electronic autocollimator device, such as those manufactured by Möller-Wedel. The autocollimator is positioned to pass collimated light through the windshield and measures the angular separation between the reflections from the two outer surfaces. Such devices employ a He—Ne laser as the light source, effectively measuring the wedge angle of a precise location, for example a diameter of about 1 mm. The wedge angle of the windshield, α, in the location measured can be calculated from the following equation, where ⊖=the measured reflection separation angle, and n=the index of refraction of the sample. A wedge angle profile of the windshield can be created by repeating this measurement at a desired spacing along a vertical line through the HUD region(s) of the windshield(s).

α=θ/n

From the measured wedge angle profile of the windscreen a wedge angle rate-of-change profile can be determined. This is done by calculating a point-by-point linear regression slope over a 50 mm span (+/−25 mm from each point) from the measured local wedge angle data. A 50 mm span is chosen as it generally corresponds with a typical range of motion that may occur by a viewer of the head-up display within a typical HUD eyebox region. The resulting rate-of-change data as a function of position is assembled to form a wedge angle rate of change profile for the windscreen.

Although described herein with respect to windshields for automobiles, it should be understood that multiple layer panels including interlayers as described herein may be used for a variety of applications, including as automotive side or rear windows, as aircraft windshields and windows, as well as windshields and panels for other transportation applications, including marine applications, rail applications, motorcycle applications, and other recreational motor vehicles.

The following examples are intended to be illustrative of the present invention in order to teach one of ordinary skill in the art to make and use the invention and is not intended to unnecessarily limit the scope of the invention in any way.

### EXAMPLES

The Examples described below are poly(vinyl butyral) wedge interlayers suitable for use in automotive windscreens with HUD systems. The Examples have different target wedge angles that are based on the requirements for a specific vehicle model and geometry for which it is designed. The use of examples with particular target wedge angles are for demonstration purposes only and should not be considered as limiting in any way. The wedge interlayers can be prepared by extrusion (or coextrusion) to form interlayer sheets with tapered (wedge) thickness profiles and conventional wedge angle rates of change. Comparative Examples were produced using existing standard extrusion processes and controls for producing interlayers. The Examples according to this invention are produced to have wedge angle rates of change that are lower than those in the Comparative Examples.

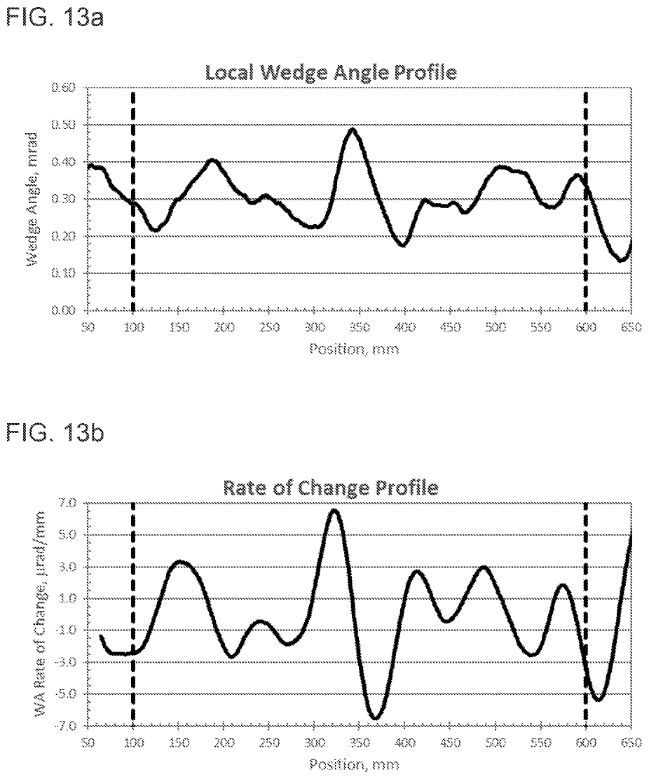

Once the interlayer is laminated between glass to form a windscreen, the local wedge angle profile can be measured as described above. Subsequently, the wedge angle rate of change profile can be calculated from the local wedge angle profile as described above. A line pattern HUD image with a six-meter virtual image distance is then projected onto the laminates prepared with each interlayer, and the laminates are visually inspected for the presence of dynamic ghosting. The Table below shows the results of the measurements and whether dynamic ghosting would be present in each of the prepared laminates. FIGS. 13a,b to 20a,b show the local wedge angle profiles and rate of change profiles for each of the Examples and Comparative Examples described below.

### Comparative Example 1

A monolithic wedge PVB interlayer with a 0.30 mrad global wedge angle produced using standard extrusion processes for producing automotive interlayers was laminated between two pieces of glass using standard lamination techniques. A standard or typical glass lamination process comprises the following steps: (1) assembly of the two glass substrates and interlayer; (2) heating the assembly via an IR radiant or convective means for a short period; (3) passing the assembly into a pressure nip roll for the first deairing; (4) heating the assembly a second time to an appropriate temperature (such as about 50° C. to about 120° C.) to give the assembly enough temporary adhesion to seal the edge of the interlayer; (5) passing the assembly into a second pressure nip roll to further seal the edge of the interlayer and allow further handling; and (6) autoclaving the assembly at an appropriate temperature and pressure, such as temperatures between 80 and 150° C. and pressures between 15 psig and 200 psig for about 30 to 90 minutes. An alternate lamination process involves the use of a vacuum laminator that first de-airs the assembly and subsequently finishes the laminate at a sufficiently high temperature and vacuum. FIG. 13a depicts the local wedge angle profile and FIG. 13b depicts the wedge angle rate of change profile of the resulting interlayer. The resulting maximum local wedge angle deviation is 0.19 mrad, and the maximum absolute rate of change is 6.5 μrad/mm. Upon visual inspection of the HUD image, dynamic ghosting is observed in multiple locations within the image.

### Comparative Example 2

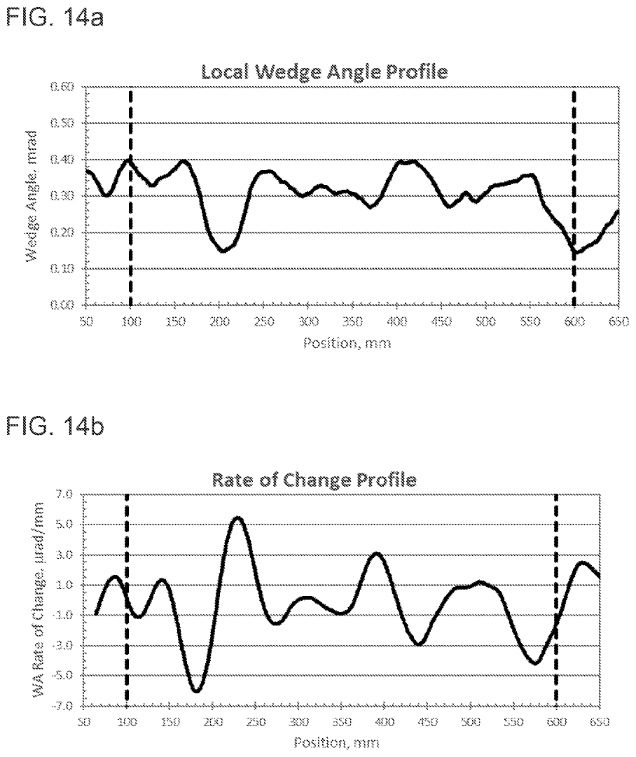

A monolithic wedge PVB interlayer with a 0.30 mrad global wedge angle was produced using standard extrusion processes for producing automotive interlayers was produced and a laminate was formed in the same manner as in Comparative Example 1. FIG. 14a depicts the local wedge angle profile and FIG. 14b depicts the wedge angle rate of change profile of the resulting interlayer. The resulting maximum local wedge angle deviation is 0.15 mrad, and the maximum absolute rate of change is 6.1 μrad/mm. Upon visual inspection of the HUD image, dynamic ghosting is observed in multiple locations within the image.

### Comparative Example 3

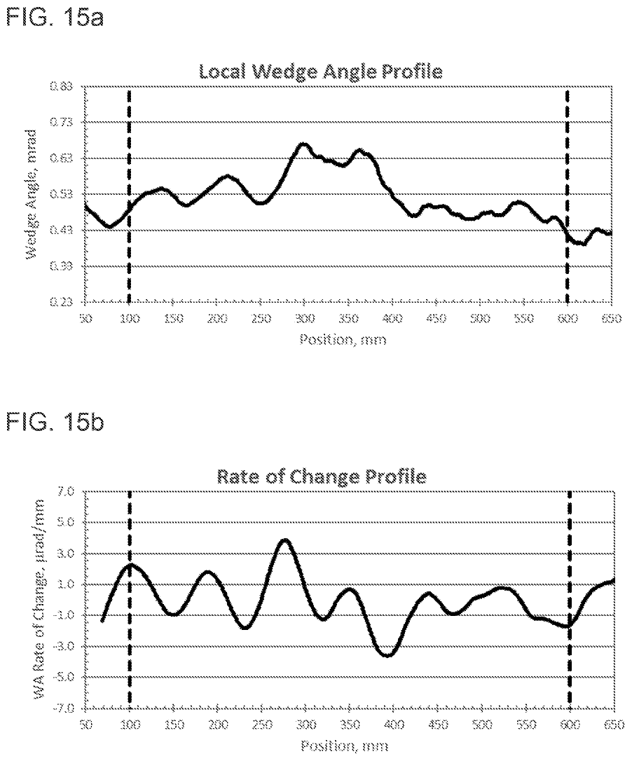

A trilayer wedge PVB interlayer with a 0.53 mrad global wedge angle was produced using standard extrusion processes for producing automotive interlayers was produced and a laminate was formed in the same manner as in Comparative Example 1. FIG. 15a depicts the local wedge angle profile and FIG. 15b depicts the wedge angle rate of change profile of the resulting interlayer. The resulting maximum local wedge angle deviation is 0.14 mrad, and the maximum absolute rate of change is 3.9 μrad/mm. Upon visual inspection of the HUD image, dynamic ghosting is observed in two locations within the image, corresponding with interlayer positions near 280 mm and 400 mm.

### Comparative Example 4

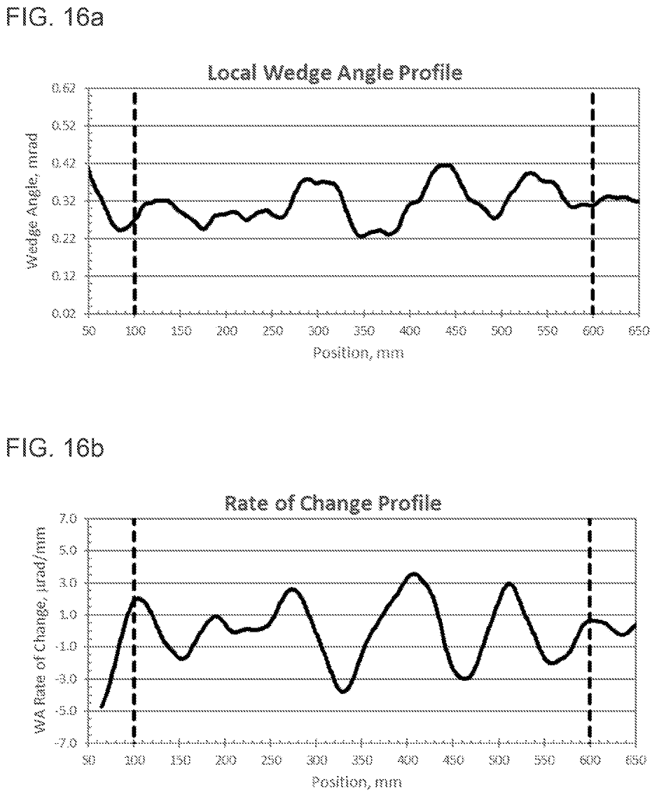

A monolithic wedge PVB interlayer with a 0.32 mrad global wedge angle was produced using standard extrusion processes for producing automotive interlayers was produced and a laminate was formed in the same manner as in Comparative Example 1. FIG. 16a depicts the local wedge angle profile and FIG. 16b depicts the wedge angle rate of change profile of the resulting interlayer. The resulting maximum local wedge angle deviation is 0.10 mrad, and the maximum absolute rate of change is 3.8 μrad/mm. Upon visual inspection of the HUD image, dynamic ghosting is observed in multiple locations within the image, corresponding with interlayer locations between 320 mm and 520 mm.

### Comparative Example 5

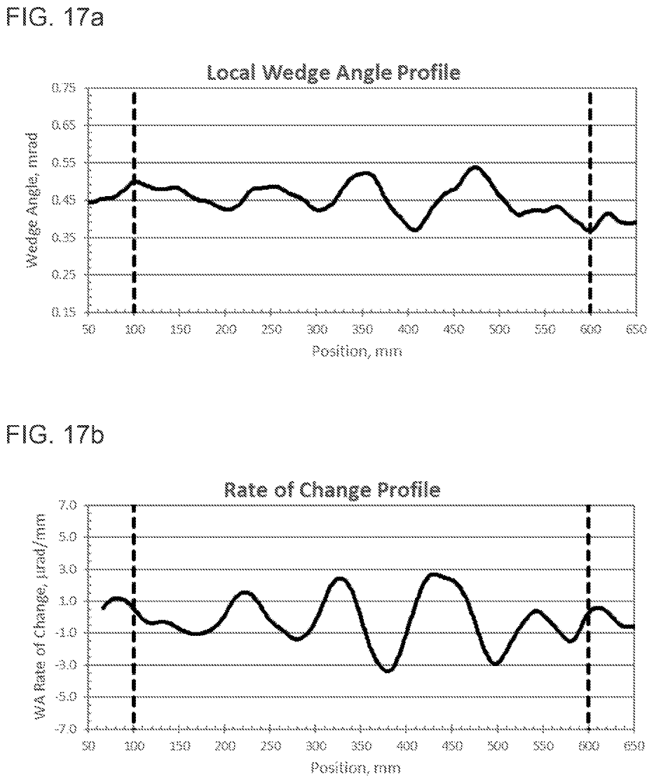

A trilayer wedge PVB interlayer with a 0.45 mrad global wedge angle was produced using standard extrusion processes and best known controls for producing automotive interlayers was produced and a laminate was formed in the same manner as in Comparative Example 1. FIG. 17a depicts the local wedge angle profile and FIG. 17b depicts the wedge angle rate of change profile of the resulting interlayer. The resulting maximum local wedge angle deviation is 0.09 mrad, and the maximum absolute rate of change is 3.4 μrad/mm. Upon visual inspection of the HUD image, dynamic ghosting is observed in the image, corresponding with an interlayer location near 380 mm.

### Comparative Example 6

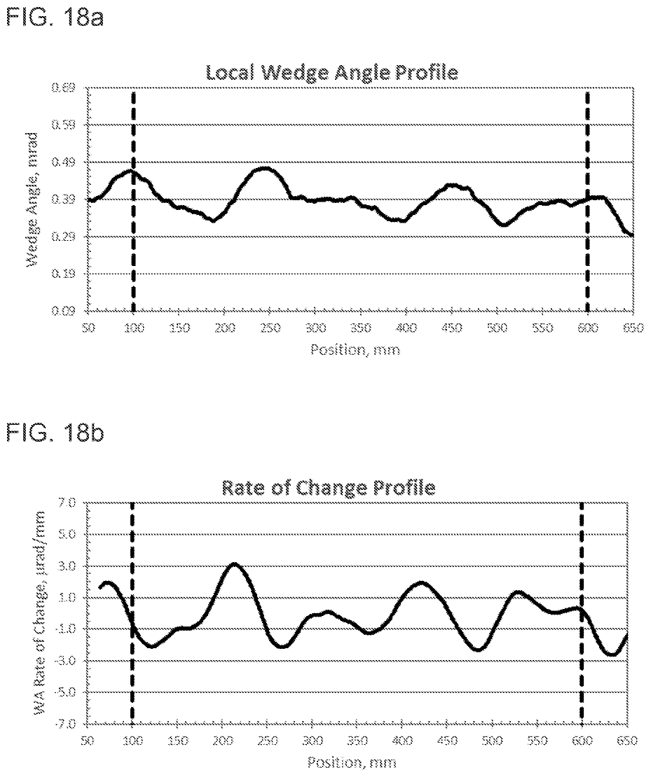

A trilayer wedge PVB interlayer with a 0.39 mrad global wedge angle was produced using extrusion processes and best known controls for producing automotive interlayers was produced and a laminate was formed in the same manner as in Comparative Example 1. FIG. 18a depicts the local wedge angle profile and FIG. 18b depicts the wedge angle rate of change profile of the resulting interlayer. The resulting maximum local wedge angle deviation is 0.08 mrad, and the maximum absolute rate of change is 3.1 μrad/mm. Upon visual inspection of the HUD image, dynamic ghosting is observed in the image, corresponding with an interlayer location near 210 mm.

### Example 1

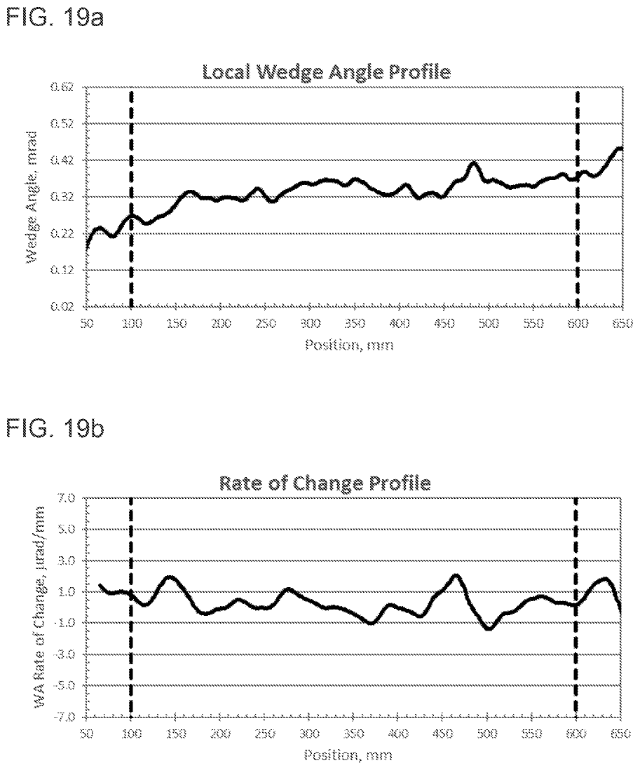

A monolithic wedge PVB interlayer with a 0.32 mrad global wedge angle was produced using improved extrusion processes for producing automotive interlayers according to this invention. Specific control measures were employed to ensure excellent wedge angle tolerance and low wedge angle rate of change throughout the HUD zone. FIG. 19a depicts the local wedge angle profile and FIG. 19b depicts the wedge angle rate of change profile of the resulting interlayer. The resulting maximum local wedge angle deviation is 0.09 mrad, and the maximum absolute rate of change is 2.1 μrad/mm. Upon visual inspection of the HUD image, dynamic ghosting is not observed in any location within the image.

### Example 2

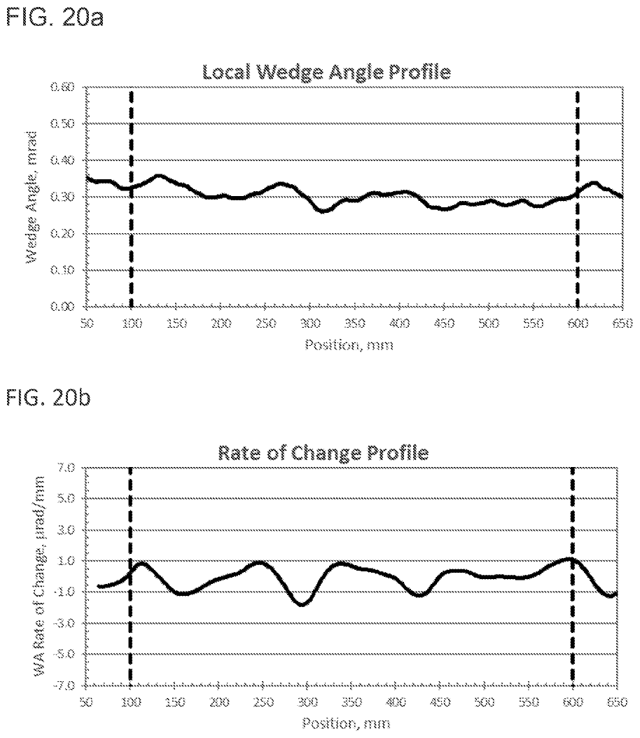

A trilayer wedge PVB interlayer with a 0.30 mrad global wedge angle was produced using improved extrusion processes for producing automotive interlayers according to this invention. Specific control measures were employed to ensure excellent wedge angle tolerance and low wedge angle rate of change throughout the HUD zone. FIG. 20a depicts the local wedge angle profile and FIG. 20b depicts the wedge angle rate of change profile of the resulting interlayer. The resulting maximum local wedge angle deviation is 0.06 mrad, and the maximum absolute rate of change is 2.0 μrad/mm. Upon visual inspection of the HUD image, dynamic ghosting is not observed in any location within the image.

The laminates made were ranked according to the maximum value of their rate of change deviation from zero and the maximum deviation of the local wedge angle from their target wedge angle. A line pattern head-up display image with a six-meter virtual image distance is projected onto the prepared laminates, and the laminates are visually inspected for the presence of dynamic ghosting. The Table below shows that the dynamic ghosting inspection correlates with the maximum absolute wedge angle rate of change. By minimizing the wedge angle rate of change to levels throughout the HUD zone lower than those previously produced, specifically to levels of less than 4 μrad/mm, dynamic ghosting can be effectively eliminated.

TABLE

| | | Max LWA | Max ROC | Visible |
|---|---|---|---|---|
| | | Deviation | Deviation | Dynamic |
| Example # | Description | (mrad) | (μrad/mm) | Ghosting |
| Comp Ex 1 | standard monolithic wedge | 0.19 | 6.5 | Yes |
| Comp Ex 2 | standard monolithic wedge | 0.15 | 6.1 | Yes |
| Comp Ex 3 | standard trilayer wedge | 0.14 | 3.9 | Yes |
| Comp Ex 4 | standard monolithic wedge | 0.10 | 3.8 | Yes |
| Comp Ex 5 | standard better trilayer wedge | 0.09 | 3.4 | Yes |
| Comp Ex 6 | standard better trilayer wedge | 0.08 | 3.1 | Yes |
| Ex 1 | improved monolithic wedge | 0.09 | 2.1 | No |
| Ex 2 | improved trilayer wedge | 0.06 | 2.0 | No |

As shown in FIGS. 13a, 14a, 15a, 16a, 17a, 18a, 19a and 20a, the wedge angle profile varies around the target or specified wedge angle. If the wedge angle varies less than ±0.15 from the target, at short or standard VIDs of about 2 to 3 m, the ghosting is generally considered acceptable to the driver (resulting in less than about 1.5 arc-min separation).

To provide acceptable ghosting at longer VIDs, a tighter tolerance (or variation from target) is necessary. Due to the variation from the wedge angle target, ghosting occurs in areas where the localized wedge angle is above or below the limit, but this type of deviation represents a constant ghosting of a certain amount. If the rate of change of the wedge angle variation over this range is a low rate of change, the perceived degree of ghosting would not change with normal head or eye movement (i.e., there would be no dynamic ghosting). On the other hand, if the rate of change of the wedge angle variation over this range is high (i.e., greater than about 3 μrad/mm), dynamic ghosting is present due to the steep rates of change in wedge angle over short periods. FIGS. 13b, 14b, 15b, 16b, 17b and 18b all have steep or high rates of change, as described above and shown by the results in the Table, therefore there would be perceived dynamic ghosting. FIGS. 19b and 20b have low rates of change and therefore would have no dynamic ghosting visible to the driver.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A wedge-shaped interlayer comprising at least one polymer layer, wherein said wedge-shaped interlayer defines a head-up display (HUD) region having a target vertical wedge angle, an actual vertical wedge angle and an absolute wedge angle rate of change, wherein the absolute wedge angle rate of change is less than 3.0 μrad/mm throughout the entire HUD region.

2. The wedge-shaped interlayer of claim 1, where the polymer layer comprises a poly(vinyl acetal) resin and at least one plasticizer.

3. A wedge-shaped interlayer comprising at least one polymer layer comprising a poly(vinyl acetal) resin and at least one plasticizer, wherein said wedge-shaped interlayer defines a head-up display (HUD) region having a target vertical wedge angle, an actual vertical wedge angle and an absolute wedge angle rate of change, wherein the absolute wedge angle rate of change is less than 3.0 μrad/rim throughout the entire HUD region.

4. The wedge-shaped interlayer of claim 1, further comprising a second polymer layer.

5. The wedge-shaped interlayer of claim 4, further comprising a third polymer layer, wherein the second polymer layer is between the first polymer layer and the third polymer layer.

6. The wedge-shaped interlayer of claim 5, wherein the second and third polymer layers comprise a poly(vinyl acetal) resin and at least one plasticizer.

7. The wedge-shaped interlayer of claim 5, wherein at least one of the second and third polymer layers comprise a polymer different from at least one of the other polymer layers.

8. The wedge-shaped interlayer of claim 1, further comprising at least one additive comprising a solar absorber.

9. The wedge-shaped interlayer of claim 1, wherein the actual vertical wedge angle profile varies from the target vertical wedge angle profile by no more than 0.10 mrad.

10. A windscreen for head-up display comprising a first glass layer, the interlayer of claim 1, and a second glass layer.

11. A laminate for head-up display comprising a first glass layer and the interlayer of claim 1.

12. A method of making an interlayer comprising forming an interlayer to provide a formed interlayer, wherein the formed interlayer defines a HUD region, and wherein the forming is carried out such that at least 50 percent of the HUD region of the formed interlayer has a vertical wedge angle profile that varies from the prescribed vertical wedge angle profile for the HUD region of said target interlayer by no more than 0.10 mrad; and wherein the interlayer has an absolute wedge angle rate of change, wherein the absolute wedge angle rate of change is less than 3.0 μrad/rim throughout the entire HUD region.

13. The method of claim 12, wherein the interlayer comprises a poly(vinyl acetal) resin and at least one plasticizer.

14. The method of claim 12, wherein the interlayer comprises at least two layers.

15. The method of claim 12, wherein the interlayer comprises at least three layers.

16. The wedge-shaped interlayer of claim 3, further comprising a second polymer layer.

17. The wedge-shaped interlayer of claim 16, further comprising a third polymer layer, wherein the second polymer layer is between the first polymer layer and the third polymer layer.

18. The wedge-shaped interlayer of claim 17, wherein the second and third polymer layers comprise a poly(vinyl acetal) resin and at least one plasticizer.

19. The wedge-shaped interlayer of claim 16, wherein at least one of the second and third polymer layers comprise a polymer different from at least one of the other polymer layers.

20. The wedge-shaped interlayer of claim 3, wherein the actual vertical wedge angle profile varies from the target vertical wedge angle profile by no more than 0.10 mrad.
